(19) United States
(12) Patent Application Publication
(10) Pub. No.: US 2023/0248131 A1
(43) Pub. Date: Aug. 10, 2023

(54) BAGGAGE ALERT LOCK

(71) Applicant: Edgar Yee Kuo WAN, Toronto (CA)

(72) Inventor: Edgar Yee Kuo WAN, Toronto (CA)

(21) Appl. No.: 18/155,010

(22) Filed: Jan. 16, 2023

Related U.S. Application Data
(63) Continuation-in-part of application No. 17/166,565, filed on Feb. 3, 2021, now Pat. No. 11,557,191.
(60) Provisional application No. 62/969,511, filed on Feb. 3, 2020.

(51) Int. Cl. A45C 13/24; A45C 13/42; E05B 65/52

(52) U.S. Cl. CPC A45C 13/24; A45C 13/42; E05B 65/52

(57) ABSTRACT

A method for tracking pieces of baggage comprises the steps of providing one or more first devices, each of the first devices being attached to the pieces of baggage and each of the first devices comprising a first transceiver; transmitting, by each of the first transceivers, wireless data, the wireless data comprising a device identifier for the respective first device; providing a second device, the second device comprising a second transceiver and a user interface; receiving, by the second transceiver, the wireless data from one or more of the first transceivers; displaying on the user interface the device identifiers corresponding to the respective first devices from which the wireless data was received; selecting one or more of the device identifiers, the selected one or more of the device identifiers corresponding to the first devices that are selected for tracking; and generating, by the second device, an alarm if one of the first devices that are selected for tracking moves beyond a particular distance from the second device, wherein the particular distance may be determined using a signal strength of the wireless data received by the second transceiver.

### CROSS-REFERENCE TO RELATED APPLICATIONS

This application is a continuation-in-part of U.S. patent application Ser. No. 17/166,565 filed Feb. 3, 2021, which claims the benefit of U.S. Provisional Patent Application No. 62/969,511 filed Feb. 3, 2020, the contents of all of which are hereby incorporated by reference.

### FIELD OF THE INVENTION

The present invention relates to apparatuses for tracking items, and in particular, to apparatuses for tracking and locating bags and other personal items.

### BACKGROUND OF THE INVENTION

It is common for people to carry various personal items with them when travelling or otherwise away from home. For example, people may carry items such as handbags, purses, backpacks, briefcases, or the like with them. From time to time, those items may be misplaced or even stolen by unscrupulous thieves.

By way of example, air travel is a very common occurrence. During flight, the baggage of the passengers is typically stored separate from the passenger cabin. After landing, the passengers must retrieve their baggage, typically from a common baggage retrieval area in the airport. The baggage may be delivered to the common baggage retrieval area using conveyor belts, with the passengers manually picking up their baggage when they see it. This can cause confusion since the design and appearance of many baggage pieces look similar. In addition, depending on the number of passengers on the flight and/or the general level of activity at the airport, the common baggage retrieval area may be quite crowded, as the passengers jockey about to identify their baggage near the conveyor belts. It is therefore quite possible for a passenger to mistakenly take baggage belonging to another passenger.

There is therefore a need to improve the identification of one's baggage by passengers to reduce the likelihood of a passenger taking the wrong baggage. In addition, there is also a need to decrease the amount of overcrowding near the conveyor belts as the passengers' baggage is being delivered.

### SUMMARY OF THE INVENTION

In accordance with one embodiment of the invention, a system for identifying passenger baggage comprises one or more locks and one or more communication devices. The lock may be built into the baggage or be a separate unit to lock the baggage. The communication device may be embodied as a separate unit or as a software application running on a smartphone, a tablet, a laptop computer, a smartwatch or the like. Both the lock and the receiver have the ability to receive wireless communications through cellular network, Wifi, Bluetooth and/or other technology.

Each of the locks has a unique identifier, which is captured by the communication device when in use. Once the lock is on the conveyor belt and within a preset distance from the receiver, a signal from the lock is picked up by the communication device. The communication device is configured to perform the following: (1) record the time when the signal is picked up (e.g. 50 feet or a pre-set distance from the lock; (2) a light on the lock will be turned on once the signal is received by the communication device; (3) upon receipt of the signal(s), the communication device will display all the identifiers of the locks that are within the pre-set distance; and (4) if the lock is moved out of the pre-set range, a flashing light on the lock will illuminate.

If a piece of baggage with the lock is mistakenly picked up by someone and moves out of the pre-set range, the identifier will no longer be displayed by the receiver. At that time, receiver may be configured to cause the light to flash, drawing attention of the person that has mistakenly taken the wrong baggage.

In one aspect of the invention, a method for tracking pieces of baggage comprises the steps of providing one or more first devices, each of the first devices being attached to the pieces of baggage and each of the first devices comprising a first transceiver; transmitting, by each of the first transceivers, wireless data, the wireless data comprising a device identifier for the respective first device; providing a second device, the second device comprising a second transceiver and a user interface; receiving, by the second transceiver, the wireless data from one or more of the first transceivers; displaying on the user interface the device identifiers corresponding to the respective first devices from which the wireless data was received; selecting one or more of the device identifiers, the selected one or more of the device identifiers corresponding to the first devices that are selected for tracking; and generating, by the second device, an alarm if one of the first devices that are selected for tracking moves beyond a particular distance from the second device, wherein the particular distance may be determined using a signal strength of the wireless data received by the second transceiver.

In another aspect of the invention, the first device further comprises a locking mechanism for securing contents of the piece of baggage.

In still another aspect of the invention, the first device further comprises a light,

In a further aspect of the invention, the method further comprises transmitting, by the second device, the alarm to the one of the first devices; and receiving, by the one of the first devices, the alarm.

In still yet a further aspect of the invention, the method further comprises upon receiving by the one of the first devices the alarm, the one of the first devices illuminating a light located on an exterior of the one of the first devices.

In another aspect of the invention, a system for tracking pieces of baggage comprises one or more locks and a communications device. Each of the one or more locks is removably attached to the pieces of baggage, and each of the locks comprises a first transceiver and a locking mechanism configured for securing contents of the pieces of baggage. The communication device comprises a user interface for displaying information and a second transceiver configured to communicate wirelessly with one or more of the first transceivers. Each of the first transceivers is configured to transmit data, the data comprising a lock identifier for the respective lock. The second transceiver is configured to receive data from one or more of the first transceivers. The communication device is configured to display on the user interface the lock identifiers corresponding to the respective locks from which data was received. The user interface is configured to accept input regarding a selection of one or more of the lock identifiers displayed on the suer interface, the selection corresponding to the respective locks selected for tracking. The communication device is further configured to generate an alarm if one of the locks selected for tracking moves beyond a particular distance, the particular distance determined using a signal strength of the data received by the second transceiver.

In still another aspect of the invention, the communication device is further configured to transmit the alarm to the lock that is moved beyond the particular distance.

In still yet another aspect of the invention, each of the locks further comprises a light located on an exterior of the lock.

In a further aspect of the invention, each of the locks is further configured to, upon receipt of the alarm, cause illumination of the light.

In another aspect of the invention, a method for tracking items comprises the steps of providing one or more first devices, each of the first devices being attached to the items and each of the first devices comprising a first transceiver and a light located on an exterior of the first device; transmitting, by the first transceivers on each of the first devices, wireless data, the wireless data comprising a device identifier for each of the respective first devices; providing a second device, the second device comprising a second transceiver and a user interface; receiving, by the second transceiver, the wireless data from one or more of the first devices; determining, by the second device, for each of the one or more of the first devices, a first approximate distance between the second device and the respective first device; displaying on the user interface each of the device identifiers corresponding to the first devices from which the wireless data was received and for which the first approximate distance is less than a first pre-set distance; selecting, using the user interface, one or more of the device identifiers, the selected one or more of the device identifiers corresponding to ones of the first devices that are selected for tracking; transmitting, by the second transceiver, a signal to the selected ones of the first devices; and upon receipt of the signal by the first transceivers on the selected ones of the first devices, illuminating of the light on the selected ones of the first devices to provide visual identification of the selected ones of the first devices.

In still another aspect of the invention, the method further comprises the steps of periodically determining, by the second device, for each of the selected ones of the first devices, a second approximate distance between the second device and respective selected ones of the first devices; generating, by the second device, an alarm if the second approximate distance for one or more of the selected ones of the first devices is greater than a second pre-set distance; transmitting, by the second transceiver, the alarm to the one or more of the selected ones of the first devices; and upon receipt of the alarm by the first transceivers on the one or more of the selected ones of the first devices, changing the illumination pattern of the light on each of the one or more of the selected ones of the first devices.

In still yet another aspect of the invention, changing the illumination pattern comprises changing the illumination of the light to a flashing pattern.

In a further aspect of the invention, each of the first devices further comprises a speaker, and the method further comprises the step of upon receipt of the alarm by the first transceivers on the one or more of the selected ones of the first devices, playing by the speaker of a sound on each of the one or more of the selected ones of the first devices.

In another aspect of the invention, the method further comprises the steps of periodically determining, by each of the selected ones of the first devices, whether the first device is still receiving communications from the second device; generating, by the first device, an alarm if the first device is no longer receiving communications second device; upon generation of the alarm by the first device, changing the illumination pattern of the light on the first device.

In still another aspect of the invention, the method further comprises the step of upon generation of the alarm by the first device, playing by the speaker of a sound on each of the one or more of the selected ones of the first devices.

In yet still another aspect of the invention, the items comprise baggage.

In a further aspect of the invention, one or more of the first devices further comprises a locking mechanism for securing contents of the baggage.

In still a further aspect of the invention, the first pre-set distance is different from the second pre-set distance.

In a further aspect of the invention, a method for tracking items comprises the steps of providing one or more first devices, each of the first devices being attached to the items and each of the first devices comprising a first transceiver and a light located on an exterior of the first device; transmitting, by the first transceivers on each of the first devices, wireless data, the wireless data comprising a device identifier for each of the respective first devices; providing a second device, the second device comprising a second transceiver and a user interface; receiving, by the second transceiver, the wireless data from one or more of the first devices; selecting, using the user interface, one or more of the device identifiers, the selected one or more of the device identifiers corresponding to ones of the first devices that are selected for tracking; periodically determining, by the second device, for each of the selected ones of the first devices, an approximate distance between the second device and respective selected ones of the first devices; generating, by the second device, an alarm if the approximate distance for one or more of the selected ones of the first devices is greater than a pre-set distance; transmitting, by the second transceiver, the alarm to the one or more of the selected ones of the first devices; and upon receipt of the alarm by the first transceivers on the one or more of the selected ones of the first devices, changing the illumination pattern of the light on each of the one or more of the selected ones of the first devices.

In another aspect of the invention, a system for tracking items comprises one or more first devices and a second device. The first devices are configured to be attached to the items, with each of the one or more first devices comprising a first transceiver and a light. The first transceiver is configured to transmit data, with the data comprising a device identifier for the first device. The light is located on an exterior of the first device. The second device comprises a user interface for displaying information and a second transceiver configured to receive data from one or more of the first transceivers. The second device is configured to, for each of the one or more of the first devices from which data is received, a first approximate distance between the second device and the respective first device. The second device is further configured to display on the user interface each of the device identifiers corresponding to the first devices from which the data was received and for which the first approximate distance is less than a first pre-set distance, and to allow for selecting, using the user interface, one or more of the device identifiers, the selected one or more of the device identifiers corresponding to ones of the first devices that are selected for tracking. The second device is further configured to transmit, using the second transceiver, a signal to the selected ones of the first devices to cause illumination of the light on the selected ones of the first devices to provide visual identification of the selected ones of the first devices.

In still another aspect of the invention, the second device is further configured to periodically determine, for each of the selected ones of the first devices, a second approximate distance between the second device and respective selected ones of the first devices, and to generate an alarm if the second approximate distance for one or more of the selected ones of the first devices is greater than a second pre-set distance.

In still yet another aspect of the invention, the second device is further configured to transmit, using the second transceiver, the alarm to the one or more of the selected ones of the first devices, and wherein the first devices are further configured, upon receipt of the alarm by the first transceivers, to change the illumination pattern of the light.

In a further aspect of the invention, each of the first devices further comprises a speaker. The first device is configured to cause the speaker to play a sound upon receipt of the alarm.

In still a further aspect of the invention, the first device is further configured to periodically determine whether the first device is still receiving communications from the second device and to generate an alarm if the first device is no longer receiving communications second device.

In still yet a further aspect of the invention, the first device is further configured to change the illumination pattern of the light upon generation of the alarm.

In another aspect of the invention, each of the first devices further comprises a speaker, and the first device is configured to cause the speaker to play a sound upon generation of the alarm.

The foregoing was intended as a summary only and of only some of the aspects of the invention. It was not intended to define the limits or requirements of the invention. Other aspects of the invention will be appreciated by reference to the detailed description of the preferred embodiments.

### BRIEF DESCRIPTION OF THE DRAWINGS

The invention will be described by reference to the detailed description of the embodiments and to the drawings thereof in which:

FIG. 1 depicts the system in accordance with the invention;

FIG. 2 depicts one of the locks of the system;

FIG. 3 depicts one of the communication devices of the system;

FIG. 4 depicts the operation of the system of FIG. 1; and

FIG. 5 depicts an embodiment of the user interface.

### DETAILED DESCRIPTION OF THE INVENTION

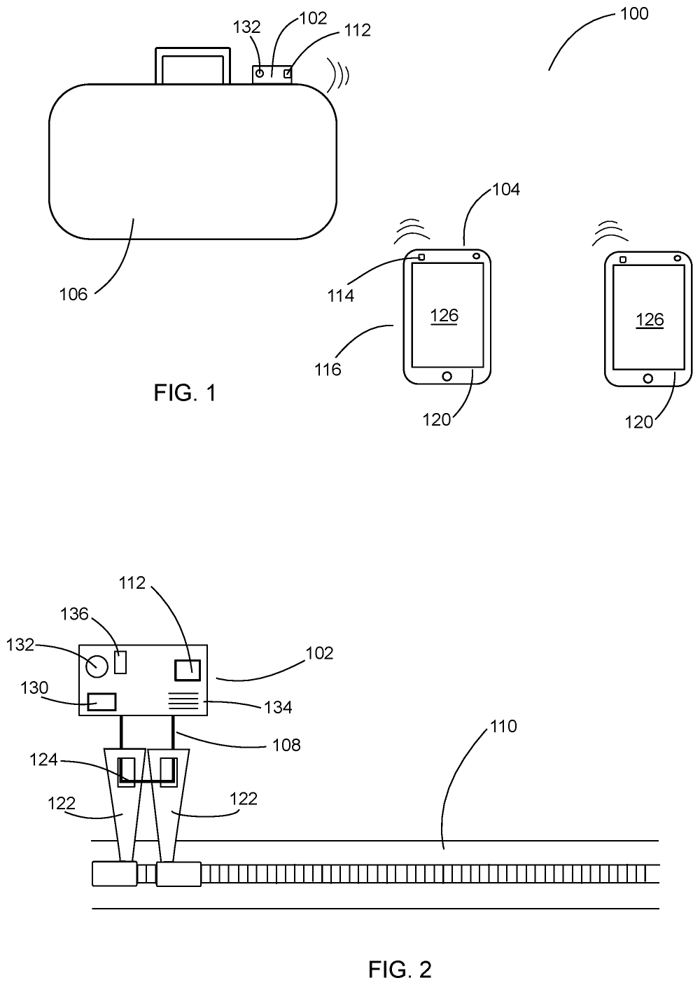

Referring to FIG. 1, in accordance with one embodiment of the invention, a system 100 for identifying and tracking items comprises one or more locks 102 and one or more communications devices 104. The lock 102 preferably may be attached to a piece of baggage 106. The baggage 106 may include luggage, suitcases, briefcases, backpacks, handbags, purses, or the like. The lock 102 may be removably attached to the baggage 106 and/or may be used to secure the contents of the baggage 106. Alternatively, the lock 102 may be integrally built into the baggage 106.

Referring to FIG. 2, the lock 102 preferably comprises a locking mechanism 108 that prevents unauthorized opening of the baggage 106. For example, if the baggage 106 includes a zipper 110 with pullers 122, the locking mechanism 108 may comprise a bar 124 that secures the pullers 122 together so as to prevent the pullers 122 from moving apart when the locking mechanism 108 is in the locked configuration. This prevents the zipper 110 from being opened (thereby restricting access to and/or hiding the contents of the baggage 106). When the locking mechanism 108 is in the unlocked configuration, the bar 124 no longer secures the pullers 122 together, thus allowing the zipper 110 to be opened and allowing access to the contents of the baggage 106. Other mechanisms for securing the baggage 106 by the locking mechanism 108 may also be used, depending on the fastening mechanism(s) used by the baggage 106. The locking mechanism 108 may use one or more mechanisms for going from the locked configuration to the unlocked configuration, including the use of a physical key, the use of a combination code, the use of a fingerprint scanner, and/or the use of face recognition or other biometrics.

The lock 102 further comprises a first transceiver 112 for sending and receiving wireless communications.

Each of the communication devices 104 comprises a second transceiver 114. The communication devices 104, using the second transceivers 114, may be able to communicate wirelessly with the locks 102, using the first transceivers 112. The first and second transceivers 112, 114 may be able to communicate wirelessly with each other through a wireless communication protocol, such as cellular network, Wi-Fi, Bluetooth, or the like.

In one embodiment, the communication devices 104 may be a mobile device 116, such as a smartphone, a tablet, a laptop computer, a smartwatch, etc., with a software application 126 configured to run on the mobile device 116. The software application 126 may be further configured to effect the operation of the second transceiver 114.

Each of the locks 102 is associated with a lock identifier 118 that is preferably unique to the particular lock 102. The lock identifier 118 may be an alphanumeric string or some other unique sequence. The lock identifier 118 may also be configured by the user beforehand so that it is more recognizable by the user. When the system 100 is in operation, each of the locks 102 will transmit one or more messages containing each of their corresponding unique lock identifiers 118 through the respective first transceivers 112. The communication devices 104, through their respective second transceivers 114, are configured to detect and receive wireless communications from any of the locks 102 that are within wireless communications range of their respective second transceivers 114.

Preferably, each of the communication devices 104 comprises a user interface 120 that is configured to display information to and/or receiving input from the user. For example, if one of the communication devices 104 receives communications from one or more of the locks 102, the communication device 104 may be configured to display on the user interface 120 the lock identifier(s) 118 of the lock(s) 102 within wireless communications range of the communication device 104. Alternatively, the communication device 104 may be configured to only display on the user interface 120 the lock identifier(s) 118 of the lock(s) 102 within a first pre-set distance of the communication device 104 (which is less than the wireless communications range of the communication device 104). For example, the first pre-set distance may be set by the user to be 50 feet or some other specified distance.

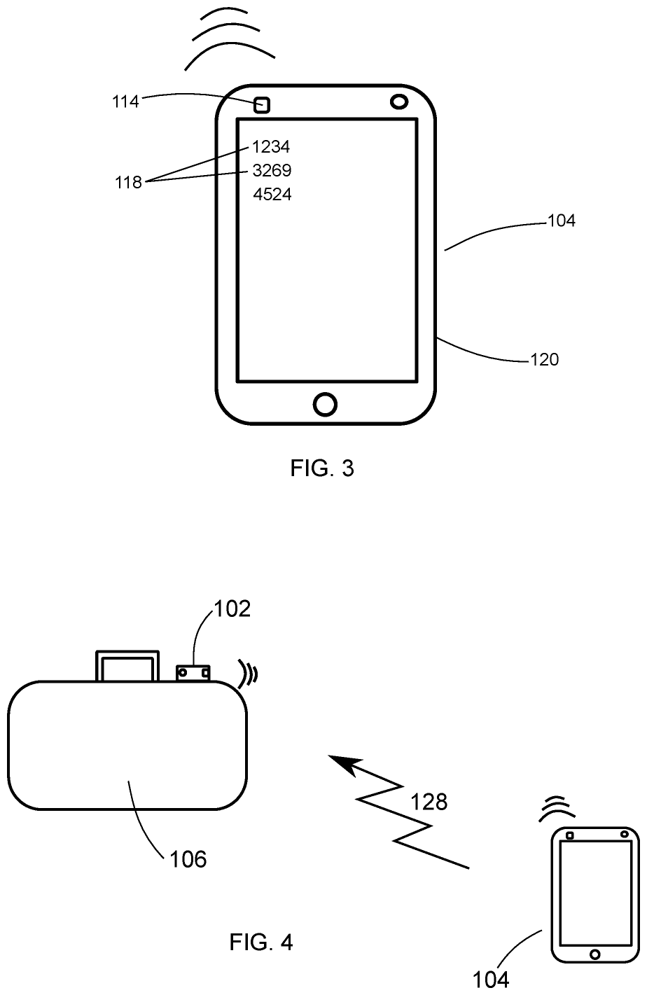

An approximate distance between the communication device 104 and the lock 102 from which the communication device 104 received communications may be determined by the communication device 104 using the signal strength of the communications received by the second transceiver 114 (e.g. using received signal strength indicator or RSSI to determine an approximate distance). If the lock identifiers 118 comprise alphanumeric strings, the lock identifier(s) 118 for the lock(s) 102 from which the communication device 104 received communications may be displayed on the user interface 120 as a list of alphanumeric strings, as shown in FIG. 3. The time at which the communications from the lock 102 is first received by the communication device 104 may be recorded by the communication device 104. Where the first pre-set distance is set by the user, the lock identifier(s) 118 for the lock(s) 102 within the first pre-set distance and from which the communication device 104 received communications may instead be displayed on the user interface 120.

The lock 102 may also comprise a light 132 located on an exterior of the lock 102 (e.g. an exterior surface of the lock 102). Preferably, the light 132 is configured to illuminate if one of the communication devices 104 is able to detect the lock identifier 118 of the lock 102. In this embodiment, if one of the communication devices 104 detects wireless communications from the lock 102, the communication device 104 is configured to transmit a signal (through the second transceiver 114) to the first transceiver 112 of the lock 102. Upon receipt of the signal by the first transceiver 112, the lock 102 is configured to cause the light 132 to illuminate, thus allowing for easier identification of the baggage 106 associated with the lock 102. In another embodiment, the communication device 104 may be configured to transmit the signal to the lock 102 only if the lock 102 is within the first pre-set distance of the communication device 104 (as determined, for example, using RSSI techniques).

Once the communication device 104 has received communications from the lock(s) 102 and has displayed the corresponding lock identifier(s) 118 on the user interface 120, the user may select to track one or more of the locks 102 displayed. The user may do so by selecting one or more of respective lock identifiers 118 on the user interrace 120. Once one or more of the lock identifiers 118 have been selected, the presence of their respective locks 102 may be tracked.

In one embodiment, the light 132 of the lock 102 is not illuminated by the lock 102 until after the respective lock identifier 118 for the lock 102 has been selected by the user. In this embodiment, once the user has selected the lock 102 on the user interface 120, the communication device 104 will transmit a signal (through the second transceiver 114) to the first transceiver 112 of the lock 102. Upon receipt of the signal by the first transceiver, the lock 102 is configured to cause the light 132 to illuminate. This will cause only the lock(s) 102 selected by the user (and presumably of interest to the user) to be illuminated, rather than all of the locks 102 within communications range of the communication device 104.

Referring to FIG. 4, in the event that the baggage 106 with the lock 102 is (for example, mistakenly) removed and taken beyond a second pre-set distance of the communication device 104, an alarm 128 will be generated by the communication device 104. The second pre-set distance may be the same as or different from the first pre-set distance. The second pre-set distance may also be specified by the user using the user interface 120.

Once the alarm 128 has been generated, the communication device 104 is configured to transmit the alarm 128 to the lock 102 to indicate that the lock 102 is out of the second pre-set distance. An approximate distance between the communication device 104 and the lock 102 may be determined by the communication device 104 using the signal strength of the communications received by the second transceiver 114 (e.g. using RSSI techniques). This may require that the lock 102 and the communication device 104 periodically exchange messages with each other in order for the communication device 104 to determine the approximate distance between the communication device 104 and the lock 102.

Alternatively, the lock 102 may be configured to also generate the alarm 128 itself if the first transceiver 112 detects that it is no longer in wireless communications with the communication device 104. This may also require that the lock 102 and the communication device 104 periodically exchange messages with each other to determine if they are still in wireless communications.

In either case, once the lock 102 is aware of the alarm 128 (whether received from the communication device 104 or generated by the lock 102 itself), the lock 102 is configured to cause the light 132 to alter its illumination condition (e.g. from being continually illuminated to now flashing intermittently), thereby alerting the person taking the baggage 106 that he or she may be taking someone else's baggage.

In one embodiment, once the lock 102 is aware of the alarm 128, the locking mechanism 108 will enter or remain in the locked configuration. The locking mechanism 108 will not enter the unlocked configuration until the alarm 128 is cancelled. This will prevent access to the baggage 106 until the alarm 128 is cancelled.

Upon generation of the alarm 128 by the communication device 104, the communication device 104 is configured to cause the user interface 120 to display an appropriate message to the user. The user interface 120 may be configured to allow the user to cancel the alarm 128. Upon cancellation of the alarm 128 by the user, the communication device 104 is configured to transmit an appropriate message to the lock 102 cancelling the alarm 128, assuming that the lock 102 is within communications range of the communication device 104.

In another embodiment, the lock 102 may also comprise a speaker 134. The lock 102 is configured cause the speaker 134 to emit noise (e.g. a siren) when the lock 102 is aware of the alarm 128. In addition, the lock 102 may be configured such that the speaker 134 plays pre-recorded sounds or messages when the lock 102 is aware of the alarm 128. For example, the user may record a voice message that would be played by the speaker 134. Alternatively, pre-recorded messages in different languages may be played by the speaker 134.

The user interface 120 may also be configured to no longer display the lock identifier(s) 118 of the lock(s) 102 once out of the first pre-set distance or, alternatively, out of wireless communications range of the communication device 104.

Although the lock 102 may be used to physically secure the contents of the baggage 106 (e.g. by attachment to the zipper 110), it is understood that the lock 102 may also take the form of a device that is attached to the baggage 106 but does not provide any physical securing of the contents. In such an embodiment, the lock 102 may simply be a tag, a name card holder, or some other similar attachment. In addition, the lock 102 may also take the form of a mobile phone or a smart device.

The lock 102 preferably comprises a power source 130 configured to provide electrical power to the components of the lock 102 (e.g. the first transceiver 112 and the light 132). The power source 130 may be a battery. In one embodiment, the lock 102 is configured to cause the light 132 to illuminate when the power source 130 is low on power. For example, the lock 102 may be configured to cause the light 132 to illuminate with a specific color (e.g. red) when the power source 130 is low on power.

In another embodiment, the lock 102 may further comprise a Global Positioning System (GPS) receiver 136 that is configured to determine location information of the lock 102. The location information may be transmitted to the communication device 104 in order to assist the user in locating the lock 102 (and the associated baggage 106).

The present invention may be employed in the following exemplary manner to track baggage, such as during travel. Prior to travel, the lock 102 is first attached by the user to the baggage 106 to be tracked. The lock identifier 118 for the lock 102 may also be set by the user. During travel, the baggage 106 may be separated from the user (such as during air travel when the baggage 106 is checked in). Once the user has arrived at the destination airport, the user can activate the communication device 104 in an area where the baggage 106 is expected to be picked up by the user (e.g. at baggage claim). The user may also set the first pre-set distance and/or the second pre-set distance using the communication device 104. The communication device 104 will attempt to receive messages from the lock 102. If the communication device 104 receives communications from the lock 102 (or from other ones of the locks 102), the communication device 104 will attempt to determine an approximate distance to each of the locks 102 from which the communication device 104 received communications. The communication device 104 will display on the user interface 120 a list of the lock identifiers 118 corresponding to the locks 102 that are within the first pre-set distance. The user may then select the lock 102 that he or she wishes to track (using the respective lock identifier 118). The communication device 104 transmits a signal to the lock 102 that was selected. The lock 102, upon receiving the signal, will cause the light 132 to illuminate. The user will thereby be alerted to the location of the baggage 106 and can then proceed to retrieve the baggage 106. In the event that someone else takes the baggage 106 and leaves with the baggage 106, once the lock 102 is outside of communications range to the communication device 104 (i.e. the communication device 104 is no longer able to receive communications from the lock 102) or the lock 102 is outside of the second pre-set distance, the alarm 128 will be generated. An appropriate message is displayed on the user interface 120. In addition, the light 132 on the lock 102 may be configured to flash and/or the speaker 134 on the lock 102 is configured to play an appropriate message (e.g. a siren or a pre-recorded message), alerting the person taking the baggage 106.

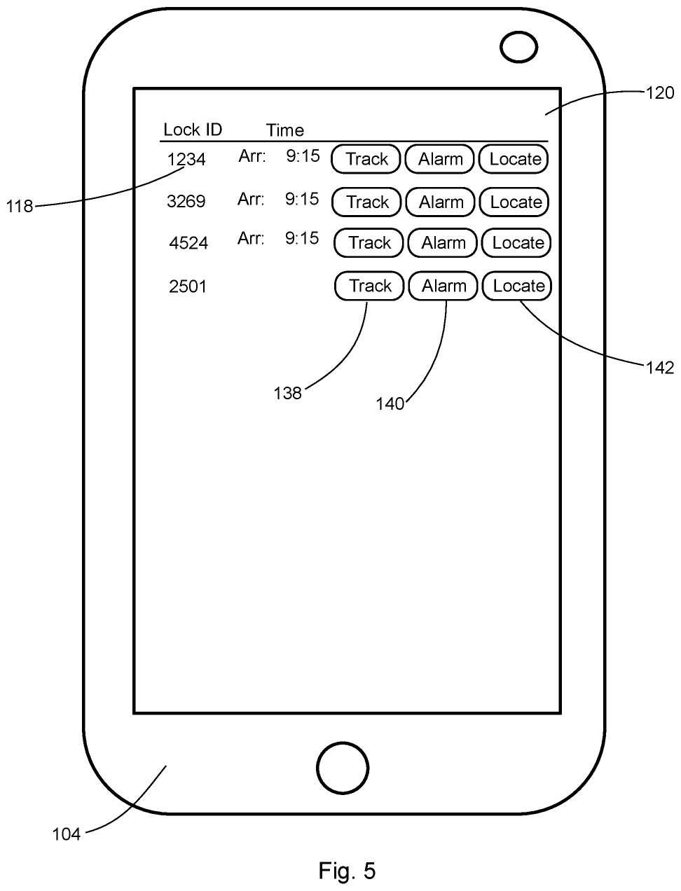

Referring to FIG. 5, an embodiment of the invention will now be described. FIG. 5 depicts an example of the user interface 120 for the communication device 104. Prior to travel, the lock 102 is first attached by the user to the baggage 106 to be tracked. The lock identifier 118 for the lock 102 may also be set by the user. During travel, the baggage 106 may be separated from the user (such as during air travel when the baggage 106 is checked in). Once the user has arrived at the destination airport, the user can activate the communication device 104 in an area where the baggage 106 is expected to be picked up by the user (e.g. on the conveyor belt at baggage claim). The user may also set the first pre-set distance and/or the second pre-set distance using the communication device 104. The communication device 104 will attempt to receive messages from the lock 102. If the communication device 104 receives communications from the lock 102 (or from other ones of the locks 102), the communication device 104 will attempt to determine an approximate distance to each of the locks 102 from which the communication device 104 received communications. The communication device 104 will display on the user interface 120 a list of the lock identifiers 118 corresponding to the locks 102 that are within the first pre-set distance. In addition, the user interface 120 displays a time and a number of buttons for each of the lock identifiers 118. The buttons may include a track button 138, an alarm button 140, and a locate button 142, as shown in FIG. 5.

The user may then select the lock 102 that he or she wishes to track by pressing the track button 138 corresponding to the lock identifier 118 for the lock 102. The communication device 104 transmits a signal to the lock 102 that was selected. The lock 102, upon receiving the signal, will cause the light 132 to illuminate. The user will thereby be alerted to the location of the baggage 106 and can then proceed to retrieve the baggage 106. In the event that someone else takes the baggage 106 and leaves with the baggage 106, once the lock 102 is outside of the second pre-set distance, the alarm 128 will be generated. This may cause the track button 138 corresponding to the lock identifier 118 for the lock 102 to flash. The user may press the alarm button 140 corresponding to the lock identifier 118 for the lock 102. This will cause the alarm 128 to be transmitted to the lock 102, which in turn will cause the light 132 on the lock 102 to flash and/or the speaker 134 on the lock 102 to play an appropriate message (e.g. a siren or a pre-recorded message), alerting the person taking the baggage 106.

If after a predetermined period of time (e.g. 10 minutes), the lock 102 is no longer outside of the second pre-set distance (e.g. it is back on the conveyor belt), the alarm 128 is deactivated, and the track button 138 may be configured to no longer flash. If after the predetermined period of time, the lock 102 is still outside of the second pre-set distance, the user may press the locate button 142 corresponding to the lock identifier 118 for the lock 102. This transmits a command from the communication device 104 to the lock 102 to activate the GPS receiver 136 on the lock 102. Location information from the GPS receiver 136 on the lock 102 may then be transmitted from the lock 102 to the communication device 104 for display on the user interface 120.

The communications between the communication device 104 and the lock(s) 102 may be through a number of wireless communications protocols, including, but not limited to, cellular network, RFID, Zigbee, Bluetooth, or Wi-Fi.

It will be appreciated by those skilled in the art that the preferred embodiments have been described in some detail but that certain modifications may be practiced without departing from the principles of the invention.

1. A method for tracking items, the method comprising the steps of:
providing one or more first devices, each of the first devices being attached to the items and each of the first devices comprising a first transceiver and a light located on an exterior of the first device;
transmitting, by the first transceivers on each of the first devices, wireless data, the wireless data comprising a device identifier for each of the respective first devices;
providing a second device, the second device comprising a second transceiver and a user interface;
receiving, by the second transceiver, the wireless data from one or more of the first devices;
determining, by the second device, for each of the one or more of the first devices, a first approximate distance between the second device and the respective first device;
displaying on the user interface each of the device identifiers corresponding to the first devices from which the wireless data was received and for which the first approximate distance is less than a first pre-set distance;
selecting, using the user interface, one or more of the device identifiers, the selected one or more of the device identifiers corresponding to ones of the first devices that are selected for tracking;
transmitting, by the second transceiver, a signal to the selected ones of the first devices; and
upon receipt of the signal by the first transceivers on the selected ones of the first devices, illuminating of the light on the selected ones of the first devices to provide visual identification of the selected ones of the first devices.

2. The method of claim 1, further comprising the steps of:
periodically determining, by the second device, for each of the selected ones of the first devices, a second approximate distance between the second device and respective selected ones of the first devices;
generating, by the second device, an alarm if the second approximate distance for one or more of the selected ones of the first devices is greater than a second pre-set distance;
transmitting, by the second transceiver, the alarm to the one or more of the selected ones of the first devices; and
upon receipt of the alarm by the first transceivers on the one or more of the selected ones of the first devices, changing the illumination pattern of the light on each of the one or more of the selected ones of the first devices.

3. The method of claim 2, wherein changing the illumination pattern comprises changing the illumination of the light to a flashing pattern.

4. The method of claim 2, wherein each of the first devices further comprises a speaker, and wherein the method further comprises the step of:
upon receipt of the alarm by the first transceivers on the one or more of the selected ones of the first devices, playing by the speaker of a sound on each of the one or more of the selected ones of the first devices.

5. The method of claim 1, further comprising the steps of:
periodically determining, by each of the selected ones of the first devices, whether the first device is still receiving communications from the second device;
generating, by the first device, an alarm if the first device is no longer receiving communications second device;
upon generation of the alarm by the first device, changing the illumination pattern of the light on the first device.

6. The method of claim 5, wherein changing the illumination pattern comprises changing the illumination of the light to a flashing pattern.

7. The method of claim 5, wherein each of the first devices further comprises a speaker, and wherein the method further comprises the step of:
upon generation of the alarm by the first device, playing by the speaker of a sound on each of the one or more of the selected ones of the first devices.

8. The method of claim 1, wherein the items comprise baggage, and wherein one or more of the first devices further comprises a locking mechanism for securing contents of the baggage.

9. The method of claim 1, wherein the first pre-set distance is different from the second pre-set distance.

10. A method for tracking items, the method comprising the steps of:
providing one or more first devices, each of the first devices being attached to the items and each of the first devices comprising a first transceiver and a light located on an exterior of the first device;
transmitting, by the first transceivers on each of the first devices, wireless data, the wireless data comprising a device identifier for each of the respective first devices;
providing a second device, the second device comprising a second transceiver and a user interface;
receiving, by the second transceiver, the wireless data from one or more of the first devices;
selecting, using the user interface, one or more of the device identifiers, the selected one or more of the device identifiers corresponding to ones of the first devices that are selected for tracking;
periodically determining, by the second device, for each of the selected ones of the first devices, an approximate distance between the second device and respective selected ones of the first devices;
generating, by the second device, an alarm if the approximate distance for one or more of the selected ones of the first devices is greater than a pre-set distance;
transmitting, by the second transceiver, the alarm to the one or more of the selected ones of the first devices; and
upon receipt of the alarm by the first transceivers on the one or more of the selected ones of the first devices, changing the illumination pattern of the light on each of the one or more of the selected ones of the first devices.

11. The method of claim 10, wherein changing the illumination pattern comprises changing the illumination of the light to a flashing pattern.

12. The method of claim 10, wherein each of the first devices further comprises a speaker, and wherein the method further comprises the step of:
upon receipt of the alarm by the first transceivers on the one or more of the selected ones of the first devices, playing by the speaker of a sound on each of the one or more of the selected ones of the first devices.

13. The method of claim 10, wherein the items comprise baggage, and wherein one or more of the first devices further comprises a locking mechanism for securing contents of the baggage.

14. A system for tracking items, the system comprising:
one or more first devices configured to be attached to the items, wherein each of the one or more first devices comprises:
a first transceiver configured to transmit data, the data comprising a device identifier for the first device; and
a light located on an exterior of the first device;
a second device comprising:
a user interface for displaying information; and
a second transceiver configured to receive data from one or more of the first transceivers;
wherein the second device is configured to, for each of the one or more of the first devices from which data is received, a first approximate distance between the second device and the respective first device;
wherein the second device is further configured to display on the user interface each of the device identifiers corresponding to the first devices from which the data was received and for which the first approximate distance is less than a first pre-set distance, and to allow for selecting, using the user interface, one or more of the device identifiers, the selected one or more of the device identifiers corresponding to selected ones of the first devices that are selected for tracking; and
wherein the second device is further configured to transmit, using the second transceiver, a signal to the selected ones of the first devices to cause illumination of the light on the selected ones of the first devices to provide visual identification of the selected ones of the first devices.

15. The system of claim 14, wherein the second device is further configured to periodically determine, for each of the selected ones of the first devices, a second approximate distance between the second device and respective selected ones of the first devices, and to generate an alarm if the second approximate distance for one or more of the selected ones of the first devices is greater than a second pre-set distance.

16. The system of claim 15, wherein the second device is further configured to transmit, using the second transceiver, the alarm to the one or more of the selected ones of the first devices, and wherein the first devices are further configured, upon receipt of the alarm by the first transceivers, to change the illumination pattern of the light.

17. The system of claim 15, wherein each of the first devices further comprises a speaker, wherein the first device is configured to cause the speaker to play a sound upon receipt of the alarm.

18. The system of claim 14, wherein the first device is further configured to periodically determine whether the first device is still receiving communications from the second device and to generate an alarm if the first device is no longer receiving communications second device.

19. The system of claim 18, wherein the first device is further configured to change the illumination pattern of the light upon generation of the alarm.

20. The system of claim 18, wherein each of the first devices further comprises a speaker, wherein the first device is configured to cause the speaker to play a sound upon generation of the alarm.
